(19) United States
(12) Patent Application Publication
(10) Pub. No.: US 2018/0351317 A1
(43) Pub. Date: Dec. 6, 2018

(54) ON-CHIP OPTICAL GAIN CIRCUITS

(71) Applicant: ANALOG PHOTONICS LLC, Boston, MA (US)

(72) Inventor: Diedrik VERMEULEN, BOSTON, MA (US)

(73) Assignee: ANALOG PHOTONICS LLC, BOSTON, MA (US)

(21) Appl. No.: 15/965,750

(22) Filed: Apr. 27, 2018

Related U.S. Application Data
(60) Provisional application No. 62/490,679, filed on Apr. 27, 2017.

(51) Int. Cl. H01S 3/067; H01S 3/10; H01S 3/16; H01S 3/094; H01S 3/23

(52) U.S. Cl. CPC H01S 3/06754; H01S 3/10023; H01S 3/2308; H01S 3/094003; H01S 3/10061; H01S 3/1608

(57) ABSTRACT

Aspects of the present disclosure describe photonic circuits that include an amplifier section or multiple amplifier sections to boost the output power of an optical transmitter and includes additional components including—but not limited to—a band pass optical filter, a wavelength demultiplexer and additional components—all on a single chip.

### CROSS REFERENCE TO RELATED APPLICATIONS

This application claims the benefit of U.S. Provisional Patent Application Ser. No. 62/490,679 filed 25 Apr. 2017 which is incorporated by reference as if set forth at length herein.

### TECHNICAL FIELD

This disclosure relates generally to integrated optical systems, methods, and structures. More particularly, it pertains semiconductor optical chips including optical gain circuits.

### BACKGROUND

There exists a continuing trend of integrating optical components onto a chip, i.e., integrated optics. Several technological routes exist to achieve such optical integration including group-III/V based platforms, e.g. InP or GaAs, or group-IV based platforms, e.g. Silicon—to name a few. As is known and understood by those skilled in the art, one key functionality for integrated optical circuits is optical gain.

Platforms that include III/V materials, either monolithically integrated, hybridly/heterogeneously integrated or integrated using co-packaging can make use of semiconductor optical amplifiers (SOA) in the optical integrated circuit. However, when using SOA's for optical amplification several problems arise: A) The small carrier lifetime of SOA's introduces a pattern affect when a modulated optical signal is amplified; B) SOA's have a temperature sensitive optical gain and gain spectrum; C) Platforms that don't include III/V materials can only integrate SOA's using co-packaging techniques of III/V based chips resulting in higher IL, chip-to-chip optical losses, higher transformation costs and limitations on the optical circuit layout freedom; D) SOA's are very small and need proper thermal management; and E) Polarization independent SOA's have a reduced saturation output power and efficiency.

Optical amplification using discrete optical components is typically realized using erbium doped optical fiber amplifiers (EDFA). Such amplifiers are very power efficient, don't have pattern effects or other non-linear effects due to the large illumination time and don't have any temperature sensitivity such that they can be used in uncooled operation. The EDF is optically pumped requiring a 980 nm or 1480 nm cooled/uncooled pump laser and wavelength (de)multiplexer (WDM). In a typical EDFA circuit an optical band-pass filter to filter the amplified spontaneous emission (ASE), variable optical attenuator (VOA), optical isolator and monitor photodetectors could be needed. An EDFA circuit compromising all the previous named components is typically made of discrete components and meters long erbium doped fiber (EDF) resulting in a large footprint.

Erbium doped waveguide amplifiers (EDWA) integrate erbium doped waveguides which provide gain either through doping of the cladding and/or the core of the waveguide. Several production techniques and waveguide architectures exist to achieve such an EDWA. An Er-doped layer can be deposited by Plasma Enhanced Chemical Vapor Deposition (PECVD), flame hydrolysis or sputtering. The refractive index of the layer can be controlled by adding metal ions such as Al or Ge through for example metal ion exchange or by adding metal precursors to the gas mixture during PECVD. The efficiency of EDWA's is worse than EDFA's due to the high waveguide losses which require a higher erbium ion concentration and thus higher pumping power. Nonetheless, for certain applications where footprint is more important than efficiency, the EDWA can be a very attractive optical gain choice.

Recent progress in EDWA is to use lithographically patterned Si or Si₃N₄ core layers in combination with locally Er-doped cladding. This type of EDWA is CMOS-compatible and can be implemented in more complex integrated photonic circuit platforms such as Silicon Photonics. The cross-section dimensions of the EDWA are optimized such that there is a large overlap between the optical mode and the Er-doped cladding.

### SUMMARY

An advance in the art is made according to aspects of the present disclosure directed to fully—or partly integrated optical circuits that include an amplifier section or multiple amplifier sections to boost the output power of an optical transmitter. It combines most of the necessary components such as a band pass optical filter, wavelength demultiplexer and additional components on a single chip.

In an illustrative embodiment and in sharp contrast to the prior art, a chip scale photonic integrated circuit includes a laser source, a splitter to split the laser light signal, a pair of polarization modulators to independently modulate the split signals and a pair of amplifiers to independently amplify the polarization modulated signals. The modulated, amplified signals are then combined prior to transmission. In another illustrative embodiment, the split signals are first amplified prior to modulation, modulated, and then further amplified. In still a further illustrative embodiment, the amplifiers share a single pump source.

### BRIEF DESCRIPTION OF THE DRAWING

A more complete understanding of the present disclosure may be realized by reference to the accompanying drawing in which:

FIG. 1 is a schematic diagram showing an illustrative, general layout of a circuit with integrated optical gain according to aspects of the present disclosure;

FIGS. 2(A)-2(F) are schematic diagrams of illustrative optical circuit layouts for an input section of FIG. 1 according to aspects of the present disclosure;

FIGS. 3(A)-3(I) are schematic diagrams of illustrative optical circuits for GAIN+WDM sections of FIG. 1 according to aspects of the present disclosure;

FIGS. 4(A)-4(E) are schematic diagrams of illustrative optical circuits for PUMP sections of FIG. 1 according to aspects of the present disclosure;

FIGS. 5(A)-5(E) are schematic diagrams of illustrative optical circuits for MODULATOR section of FIG. 1 according to aspects of the present disclosure;

FIGS. 6(A)-6(D) are schematic diagrams of illustrative optical circuits for FILTER sections of FIG. 1 according to aspects of the present disclosure;

FIGS. 7(A)-7(C) are schematic diagrams of illustrative optical circuits for the VOA section of FIG. 1 according to aspects of the present disclosure;

FIGS. 8(A)-8(B) are schematic diagrams of illustrative optical circuits for the POLARIZATION section in FIG. 1 according to aspects of the present disclosure;

FIGS. 9(A)-9(B) are schematic diagrams of illustrative optical circuits for a POLARIZATION section of FIG. 1 according to aspects of the present disclosure;

FIGS. 10(A)-10(C) are schematic diagrams of illustrative optical circuits for an ISOLATOR section of FIG. 1 according to aspects of the present disclosure; and

FIG. 11 is a schematic diagram of an illustrative fully integrated optical gain circuit of FIG. 1 according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

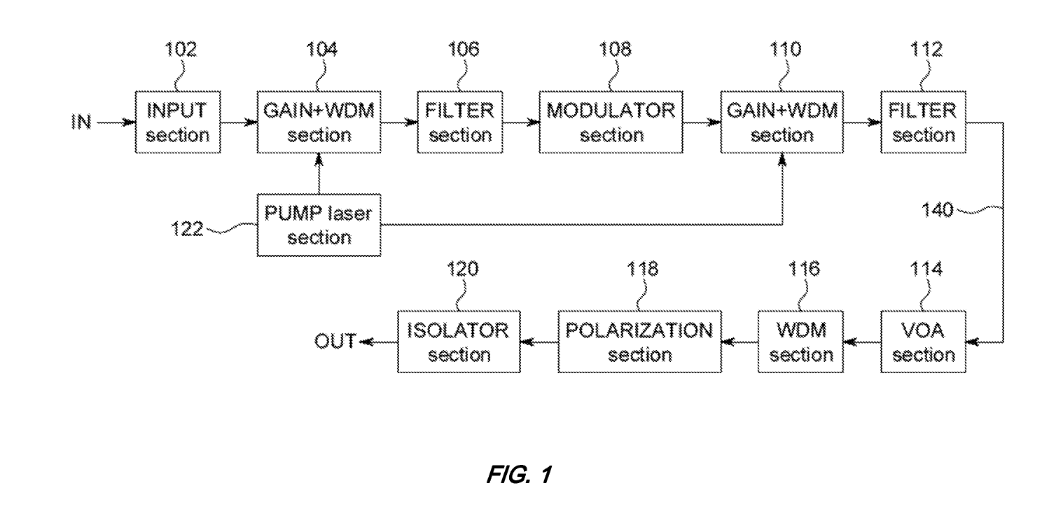

Unless otherwise explicitly specified herein, the FIGs comprising the drawing are not drawn to scale. Finally, we note that as used herein, each component is associated with a unique reference numeral. Consequently, the reader is referred to all figures included in the disclosure for reference simultaneously, namely FIG. 1-FIG. 11.

Systems, methods, and structures according to aspects of the present disclosure include a set of integrated photonic circuits used as pre or post amplifier. The circuits may advantageously make use of rare-earth doped gain sections such as Erbium either implemented in waveguide form (EDWA) or fiber form (EDF). The gain section is optically pumped using for example a 980 nm or 1480 nm pump laser(s) either located on the chip or off the chip. The light that is amplified consists out of at least one wavelength and can be either modulated or unmodulated. The gain section is either co-pumped or counter-pumped or both simultaneously.

A general, illustrative circuit according to aspects of the present disclosure is shown schematically in FIG. 1 and includes several subsections 102-120. At this point we note that for the purposes of this disclosure, additional subsections and details are provided in subsequent figures. Any interconnecting arrows such as 140 between the sub sections of FIG. 1 are optical connections and can be one or a multitude of optical waveguides. Finally, we note that with respect to this disclosure, any possible arrangement of any of the subsection(s) shown is contemplated.

Advantageously, optical circuits disclosed herein can be completely or partly integrated on one or more optical integration platforms such as Silicon Photonics or III/V. Certain components of the circuit which are impossible or impractical to monolithically integrate can be discrete components or co-packaged components. Examples are a PUMP laser 404 and an EDF 310. Other components for which the integrated components don't exhibit sufficient performance may also be chosen to be either discrete individually packaged or co-packaged components such as 202, 604, 804 and 1004.

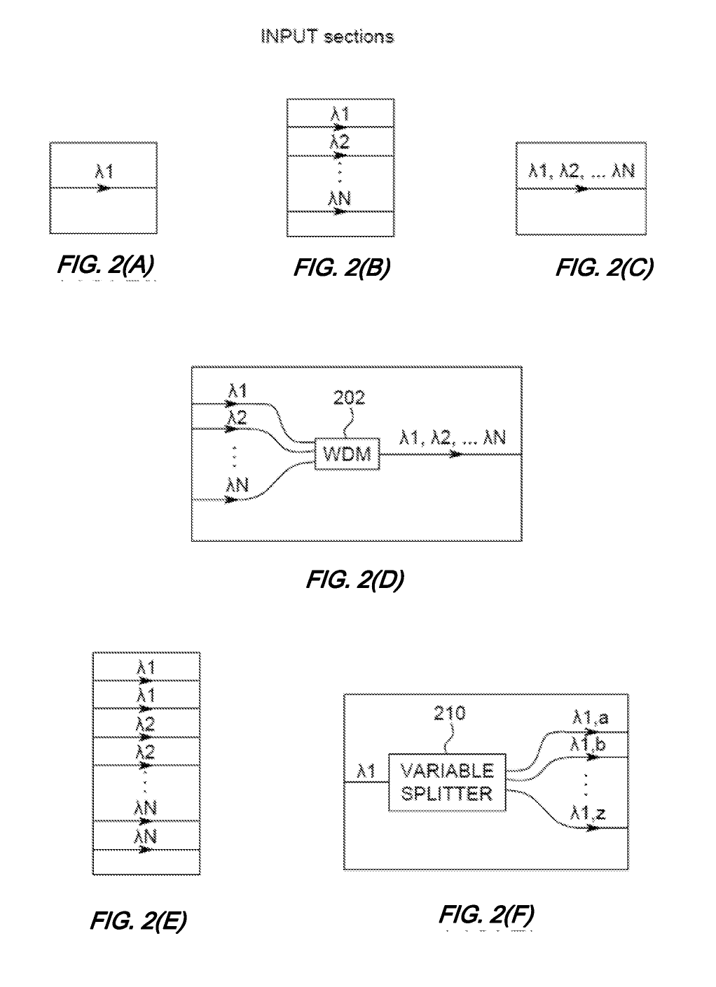

INPUT sections depicted in FIG. 2(A) through 2(F) are optical circuits suitable for use as section 102. It can be a waveguide with light containing one optical frequency or wavelength (see, e.g., FIG. 2(A)), multiple optical waveguides with each one wavelength (see, e.g., FIG. 2(B)) or one waveguide containing multiple wavelengths (see, e.g., FIG. 2(C)). Section 102 may also include a wavelength demultiplexer (WDM) 202 such that some or all wavelengths are combined into one or more waveguides (see, e.g., FIG. 2(D). It can also contain fixed or variable optical splitters to divide the light (210 in FIG. 2(F)). Any serialization or parallelization (FIG. 2(E) is an example) of these INPUT sections can also act as an INPUT section. The light in this section can be continuous wave (CW) or already modulated.

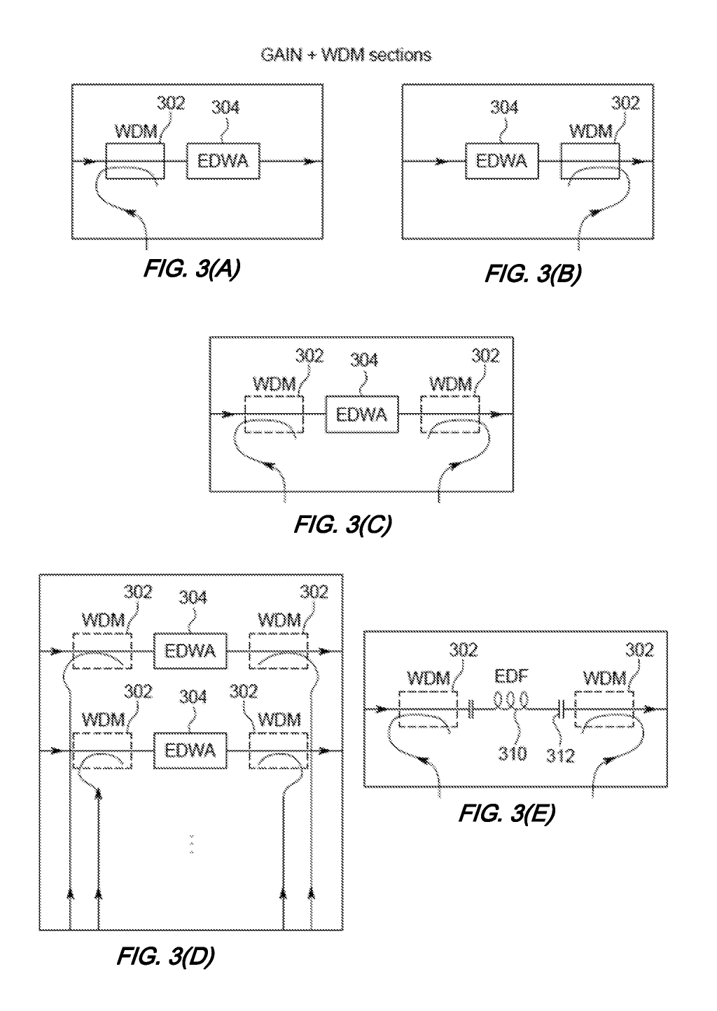

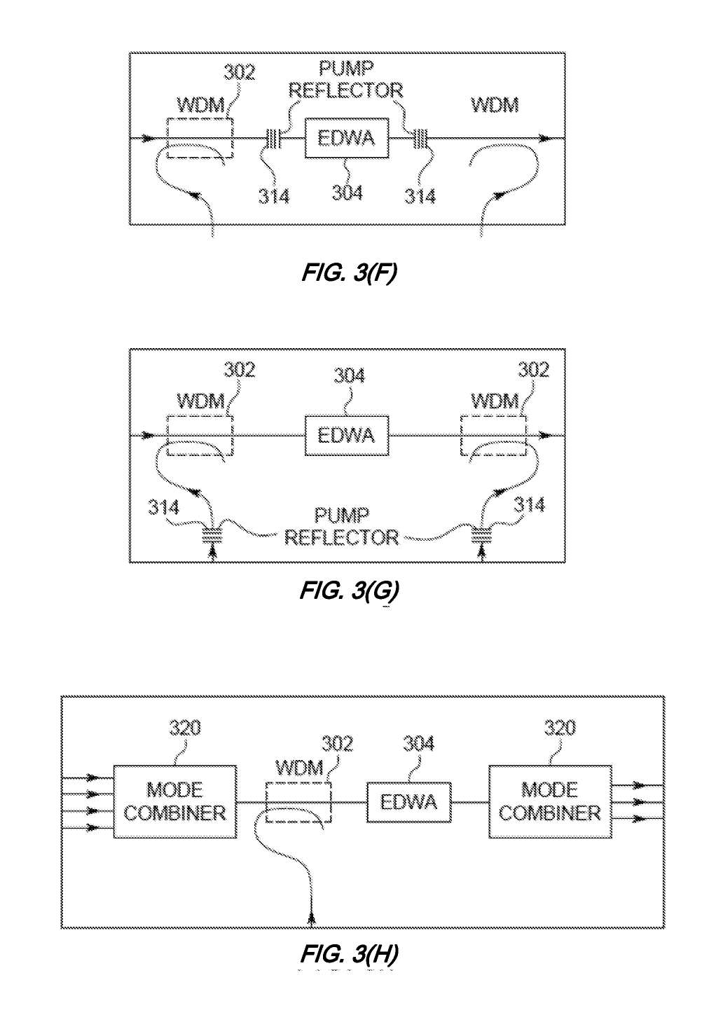

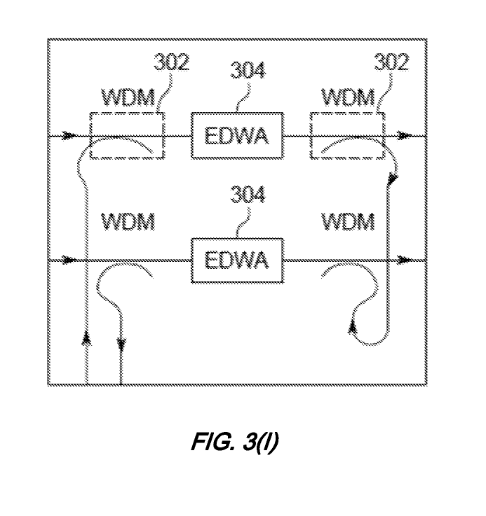

Different possibilities for the GAIN+WDM section either as pre-amplifier 104 are post-amplifier 110 are illustratively shown in FIG. 3(A) through FIG. 3(I). Such section generally contains a wavelength multiplexer (WDM) 302 which combines the carrier wavelength(s) from the input section with the PUMP light generated by the PUMP section 122. This PUMP light input is in the figures as a bottom input. The carrier light input is shown as a left side input into the block.

A gain section can be either an integrated waveguide amplifier 304 or an external fiber 310. The gain is typically achieved by Erbium doping but is not limited and can be any rare-earth element. The gain can also be a semiconductor amplifier (SOA) which is optically pumped.

The PUMP light is applied either before the amplifier (FIG. 3(A)), after the amplifier (FIG. 3(B)) or both (FIG. 3(C)). When having multiple WDM 302, each WDM can have a separate input (FIG. 3(D)) or the PUMP light of another GAIN section can be reused to pump other gain sections (FIG. 3(I)).

When a gain section is an external fiber such as 310, the efficiency will be better than having an integrated gain, but additional fiber-to-chip loss will be acquired at the fiber-to-chip interfaces 312. Another embodiment of the GAIN+WDM section is where wavelength dependent reflectors 314 are inserted to optimize the pump efficiency.

These reflectors can be inserted after the WDM (see FIG. 3(F)) or before the WDM (see FIG. 3(G)). More complicated gain sections with an example in FIG. 3(H) have gain for multiple optical modes (polarization modes or spatial modes) at the same time. To make use of this property a mode combiner 320 is needed. Besides making use of the gain for different modes, the amplifier also has gain for both the forward and backward direction which can be exploited by having two double pass gain section with a complementary interferometer circuit.

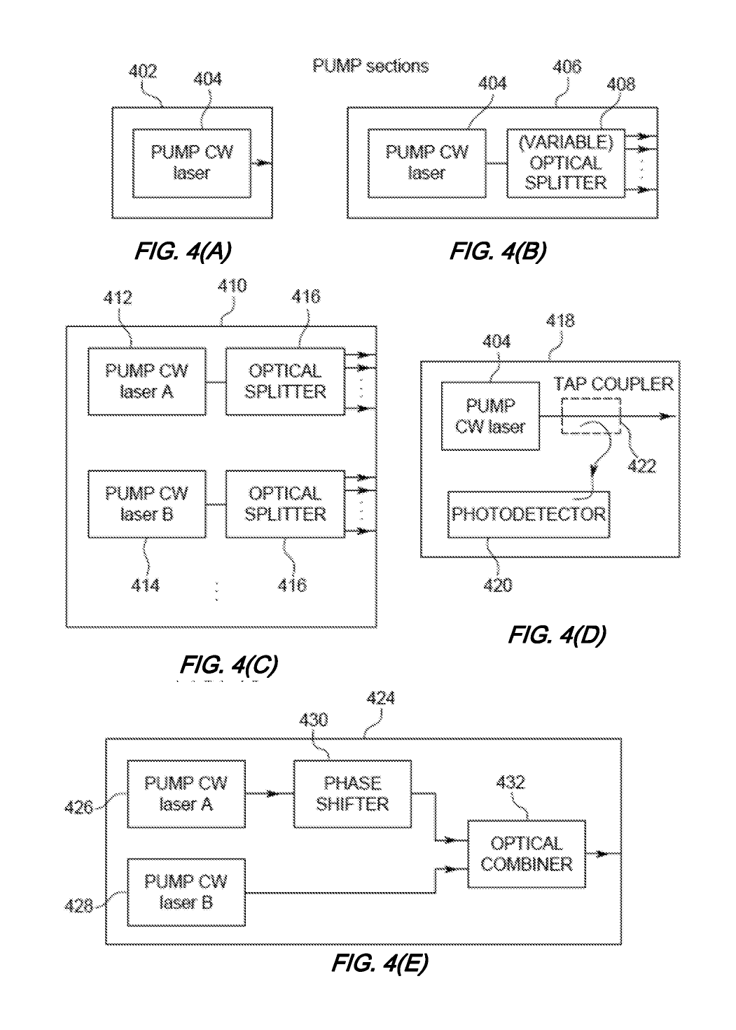

Different illustrative embodiments of a PUMP section 122 are shown in FIG. 4(A) through FIG. 4(E). This section can have one or more PUMP lasers 404, 412 and others which generate light at a wavelength complementary to gain section. For erbium doped amplifiers this is around 980 nm or 1480 nm. The light of a PUMP laser can be used to pump several gain sections. In that case a fixed or variable optical 408 and 416 is included in the PUMP section. A combination of a tap coupler 422 which extracts a part of the light and a photodetector (PD) 420 can be used to monitor the pump light intensity (see FIG. 4(D)). The power of several pump lasers 426 and 428 can be combined by coherently adding the pump light using a phase shifter 430 and optical combiner 432.

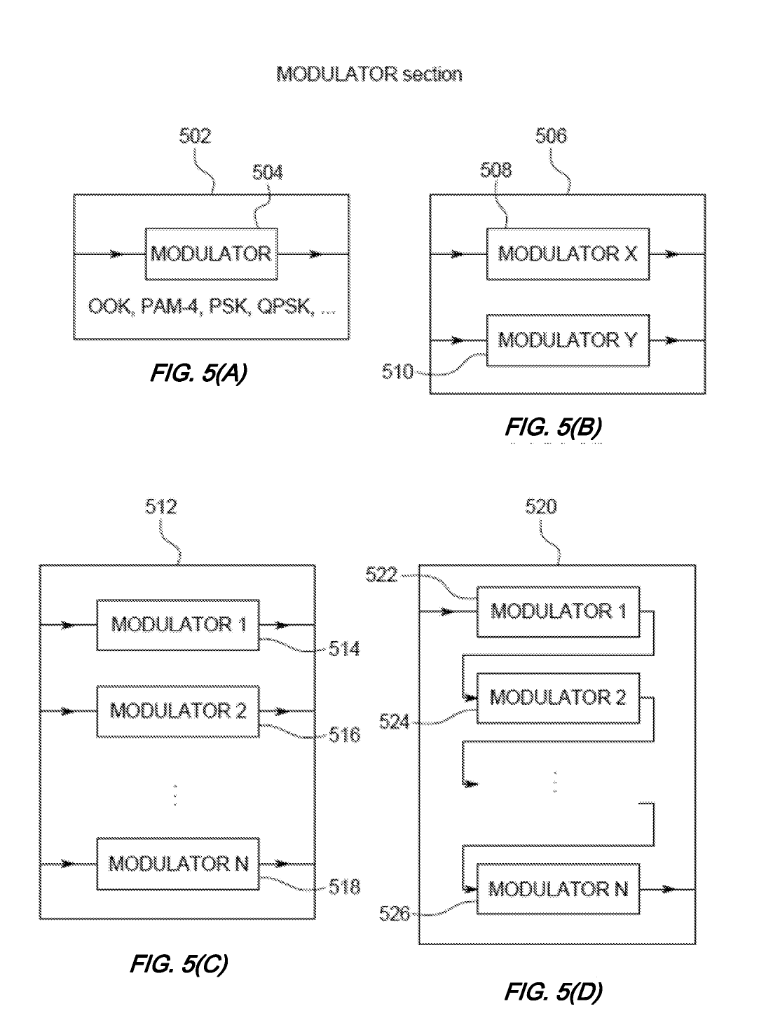

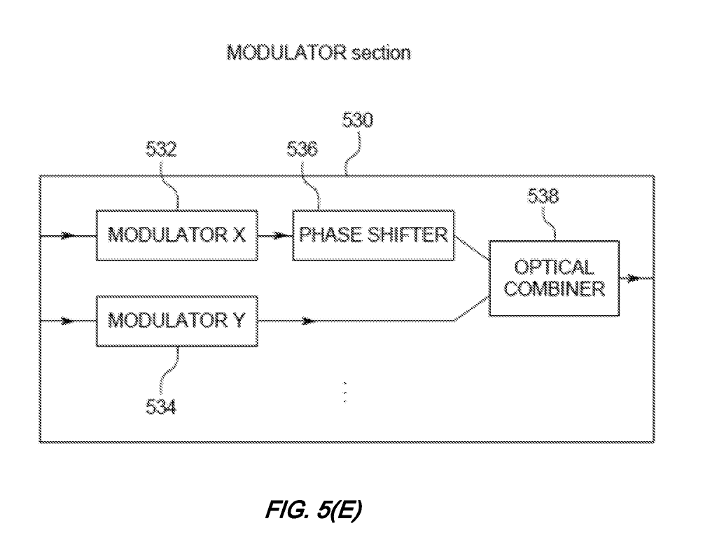

Several illustrative embodiments of the MODULATOR section 108 are shown in FIG. 5(A) through FIG. 5(E). It can be a single modulator 504 only modulating one carrier wavelength using any modulation format such on-off keying (OOK), pulse amplitude modulation (PAM) or phase modulation (PSK, QPSK). For the higher order modulation formats the modulator will exist out of a series of modulators 532 and 534, phase shifters 536 and optical combiners 538 with as example FIG. 5(E).

The MODULATOR section can also be a parallelization of modulators, modulating different polarizations (FIG. 5(B)) or different wavelengths (FIG. 5(C)). Furthermore, a series of modulators can also be in a serial configuration such as in FIG. 5(D). This is for example the case when the input waveguide contains multiple wavelengths and the modulators are wavelength dependent modulators such as ring modulators.

The optical FILTER section 106 and 112 filter the amplified spontaneous emission (ASE) generated at the GAIN sections 104 and 110. Therefore, the FILTER section will always be after the GAIN section but is not limited to be placed directly after it. 112 can for example act as a FILTER section for 104. Because an integrated filter section is typically polarization dependent it will be placed before the polarization combining section 118. But in case of a discrete filter or a polarization independent filter it can also be placed after the polarization section. The optical bandwidth of the filter in the FILTER section is dependent on the required specifications and the modulation format. In general, it's a band pass filter or multi band pass filter if multiple wavelengths were modulated and no WDM is used.

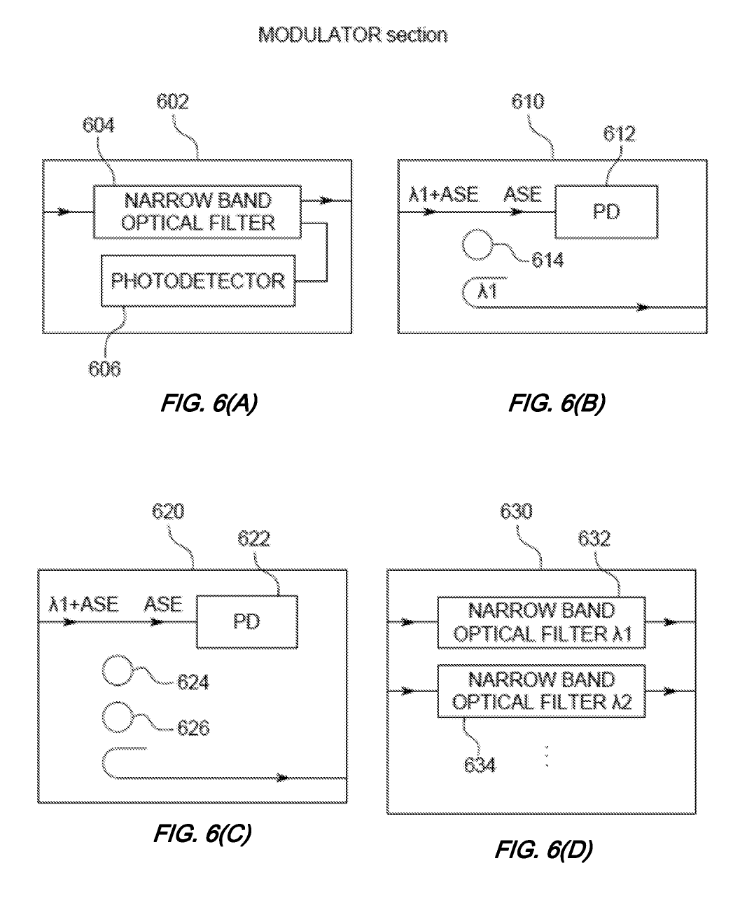

FIG. 6(A) through FIG. 6(D) show different illustrative embodiments of the FILTER sections 106 and 112. The main component is narrow band optical filter 604 (see FIG. 6(A)). Multiple filters can be parallelized (FIG. 6(D)) or serialized.

Two illustrative examples of an optical filter are 614 (a ring resonator filter with one ring) or 624/626 (a double ring resonator). These filters will drop the carrier wavelength and pass through the ASE. Because these filters are typically very sensitive, in most cases an appropriate tuning mechanism is needed. The feedback for this tuning mechanism can be an optical tap coupler and photodetector after the filter to detect the carrier wavelength band or a photodetector after the filter to detect the ASE and check if there is no carrier light present. Several control mechanisms can be used such as intensity detection or diddering of the light.

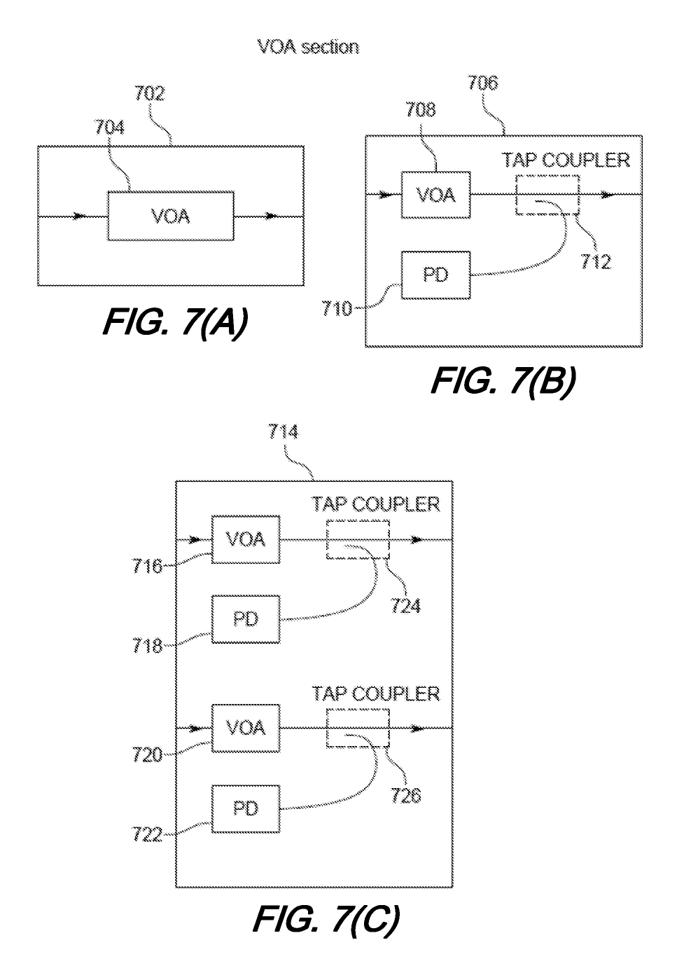

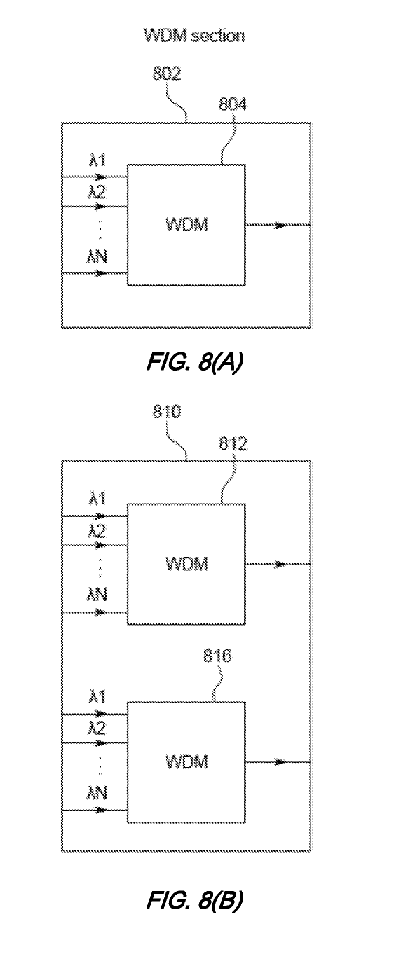

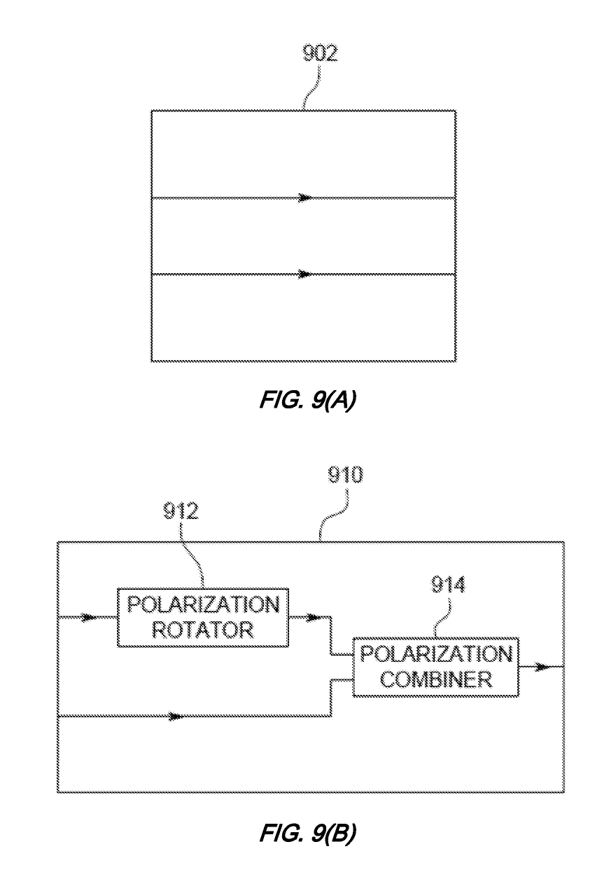

Section 114 is the VOA section and several embodiments are shown in FIG. 7(A) through FIG. 7(C). This is an optional section and the main component is one or multiple variable optical attenuators (VOA) 704 and 708. Using this the output power of each channel, polarization and wavelength can be controlled. An optical tap coupler 712 and photodetector 710 combination can be used to have a feedback for controlling the VOA.

In FIG. 8(A) the WDM 116 section is shown. FIG. 8(B) is a parallelization of FIG. 8(A). This WDM section combines different wavelengths using a wavelength demultiplexer 804. This section is necessary when more than wavelength was modulated using a parallelization of modulators and possibly gain sections. This WDM section can also be a discrete component and placed closer to the end of the general circuit in FIG. 1.

With reference to 118—there is an illustrative POLARIZATION section and includes all the polarization handling which is typically necessary when both orthogonal polarizations are modulated. Element 902 in FIG. 9(A) is employed when no polarization multiplexing is necessary. FIG. 9(B) is an illustrative example of a polarization combining circuit using a polarization rotator 912 and polarization combiner 914. We note that while not specifically shown in FIG. 1, the POLARIZATION section may advantageously be placed before any amplification. In that inventive manner, a signal is split into its component polarizations, amplified, modulated, and then subsequently amplified after modulation. When the operation is performed in this manner, a single pump laser may advantageously pump both amplification sections.

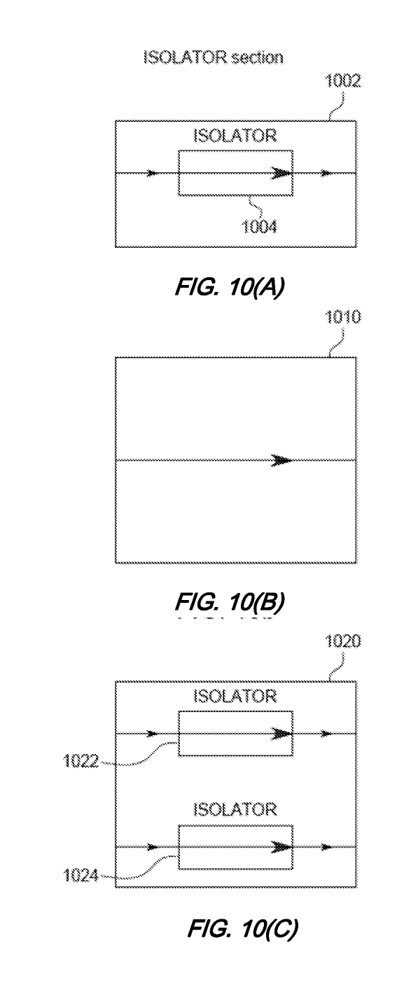

Finally, a last section shown is the ISOLATOR section 120. Integrating an isolator 1004 in FIG. 10(A) with sufficient efficiency is very challenging but not impossible. In the case of an integrated polarization dependent isolator it should be placed in front of the polarization section 118. In case of a polarization independent isolator such as a discrete isolator it will be placed after the fiber-to-chip coupling. Other possibilities are co-packaged isolators which can be inserted in the circuit and which need a lensing system.

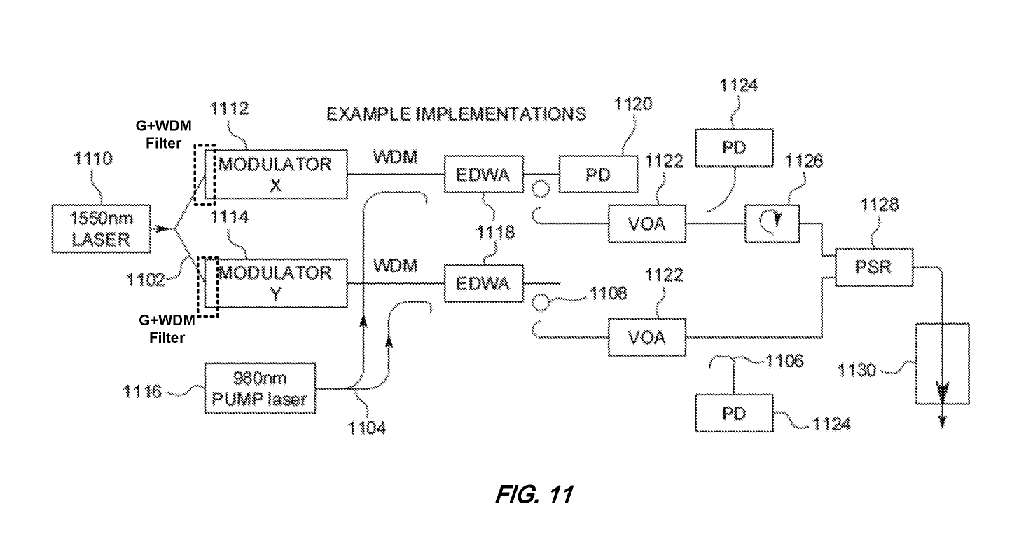

FIG. 11 shows an illustrative circuit that complies with the general circuit from FIG. 1. In this case it's on a Silicon Photonics platform combining Silicon waveguides and SiN waveguides. In general one needs to have waveguides which can both guide the carrier light and the PUMP light either in the same core or using different core layers. The circuit starts with 1550 nm continuous wave laser 1110. This laser can be co-packaged, integrated or separately packaged. The 1550 nm is divided using an optical splitter 1102 to two modulator sections.

In this example we don't explicitly a first GAIN+WDM section 104 and filter section 106, although such sections may be employed as indicated by dotted lines. Note that such gain section is prior to modulators and amplifies each polarization independently. Note further that such gain section may advantageously share pump signal of subsequent gain sections, as illustratively shown in FIG. 1. Next are two modulators 1112 and 1114 in parallel. These are general modulator blocks and can be modulate any modulation format such as OOK or QPSK. Positioned after the modulators are wavelength demultiplexers which combine the pump light from the 980 nm pump laser 1116 with the modulated signals. The pump section includes of a single pump laser and optical 3 dB splitter. The pump laser works in uncooled operation and is co-packaged. The gain sections 1118 are integrated erbium doped waveguide amplifiers (EDWA) with enough gain to reach the required transmitter specifications. After the gain sections are thermally tuned silicon ring filters 1108 which filter out the amplified spontaneous emission generated in the EDWAs. The VOAs 1122 adjust the optical intensity downwards if the output power is too large and use a tap coupler 1106 and photodetector 1124 as feedback mechanism. An integrated polarization rotator 1126 and polarization combiner 1128 end the circuit to combine both signals into one waveguide. A discrete optical isolator 1130 is used to decrease filter out any reflections. This circuit can be used as an optical transmitter and couplers to an optical fiber.

At this point, while we have presented this disclosure using some specific examples, those skilled in the art will recognize that our teachings are not so limited. Accordingly, this disclosure should be only limited by the scope of the claims attached hereto.

1. An integrated, chip-scale photonic circuit comprising:
a substrate having formed thereon:
a source laser;
a 50/50 splitter for splitting light output from the laser into two separate optical signals;
a pair of independent polarization modulators, modulator-x and modulator-y, for modulating respectively one of the two separate split optical signals;
a pair of independent GAIN/WDM sections for amplifying respectively the polarization modulated signals;
a polarization combiner for combining the amplified signals into a single combined signal.

2. The integrated, chip-scale photonic circuit of claim 1 further comprising a pump laser for pumping the pair of independent GAIN/WDM sections.

3. The integrated, chip-scale photonic circuit of claim 2 further comprising a first pair of independent GAIN/WDM sections, positioned between the splitter and the polarization modulators, for amplifying the split optical signals prior to polarization modulation.

4. The integrated, chip-scale photonic circuit of claim 3 wherein the pair of independent GAIN/WDM sections and the first pair of independent GAIN/WDM sections are optically pumped by the same single pump laser.
